(19) United States
(12) Patent Application Publication
(10) Pub. No.: US 2025/0273027 A1
(43) Pub. Date: Aug. 28, 2025

(54) INFORMATION PROCESSING APPARATUS

(71) Applicant: TOYOTA JIDOSHA KABUSHIKI KAISHA, Toyota-shi (JP)

(72) Inventors: Hiroshi KAWANISHI, Nisshin-shi (JP); Atsushi Tabata, Okazaki-shi (JP); Koichi Okuda, Toyota-shi (JP); Hideaki Bunazawa, Meguro-ku (JP)

(73) Assignee: TOYOTA JIDOSHA KABUSHIKI KAISHA, Toyoyta-shi (JP)

(21) Appl. No.: 19/027,180

(22) Filed: Jan. 17, 2025

(30) Foreign Application Priority Data
Feb. 26, 2024 (JP) 2024-026335

(51) Int. Cl. G07C 5/10; G06F 18/241

(52) U.S. Cl. CPC G07C 5/10; G06F 18/241

(57) ABSTRACT

An processing device of an information processing apparatus includes: a first step of calculating a relative frequency distribution of original data; a second step of setting a plurality of time windows for cutting out data of a partial period of the original data; a third step of cutting out data from the original data; a fourth step of calculating a relative frequency distribution in extracted data; and a fifth step of calculating an error between the relative frequency distribution in the original data and the relative frequency distribution in the extracted data, and performs a search process of repeatedly executing a trial from the second to fifth steps by changing the setting of the time windows. The processing device calculates an index value of damage of a drive motor by using the extracted data in which the error becomes equal to or smaller than a threshold value.

### CROSS-REFERENCE TO RELATED APPLICATION

This application claims priority to Japanese Patent Application No. 2024-026335 filed on Feb. 26, 2024, incorporated herein by reference in its entirety.

### BACKGROUND

### 1. Technical Field

The present disclosure relates to an information processing apparatus.

### 2. Description of Related Art

Japanese Unexamined Patent Application Publication No. 2008-108247 (JP 2008-108247 A) discloses an information processing apparatus that reduces the size of data for analysis by compressing original data for analysis. The original data for analysis is data collected over a prescribed period of time using a sensor mounted in a vehicle.

The information processing apparatus disclosed in JP 2008-108247 A compresses data by extracting data acquired at the time when a certain vehicle speed is achieved and data acquired at the time of an inflection point of the vehicle speed from original data.

### SUMMARY

The information processing apparatus described above extracts data by focusing only on the vehicle speed. Therefore, the information processing apparatus described above cannot extract data in accordance with features of data other than the vehicle speed. There is a demand for an information processing apparatus capable of obtaining extracted data that captures features of entire original data including feature amounts.

An information processing apparatus to solve the above problem acquires original data collected and created over a prescribed period of time using a plurality of sensors mounted in a vehicle and calculates an indicator value that indicates how large damage accumulated in a drive motor is. The information processing apparatus includes a processing device that executes processing. The original data includes, as feature amounts, data regarding a voltage applied to the drive motor. In the information processing apparatus, search processing executed by the processing device includes a first step of calculating, for each of the feature amounts, a relative frequency distribution in the original data in regard to the feature amounts included in the original data. The search processing includes a second step of setting a plurality of time windows for cutting data corresponding to partial periods of the original data such that a period obtained by adding up periods of all the time windows is shorter than the prescribed period. The search processing includes a third step of cutting data from the original data using the plurality of time windows. The search processing includes a fourth step of calculating, for each of the feature amounts, the relative frequency distribution in extracted data obtained by connecting the data cut using the plurality of time windows. The search processing includes a fifth step of calculating an error between the relative frequency distribution in the original data and the relative frequency distribution in the extracted data. The processing device executes the search processing of repeatedly executing a trial from the second step to the fifth step with a setting of the plurality of time windows changed after execution of the first step to extract the extracted data with which the error is equal to or less than a threshold value. The processing device calculates the indicator value using the extracted value with which the error is equal to or less than the threshold value.

According to an aspect of the information processing apparatus, the processing device executes clustering which is machine learning of categorizing data of each section obtained by sectioning the original data for each specific period into a prescribed number of clusters.

The processing device sets the plurality of time windows such that a difference between a ratio of each cluster in the extracted data and a ratio of each cluster in entire original data is equal to or less than a threshold value in the second step.

The information processing apparatus can use the extracted data, the data amount of which is smaller than the data amount of the original data, to calculate the indicator value with accuracy that is equivalent to that in the case where the original data is used. Therefore, the information processing apparatus achieves both reduction of the amount of data and maintenance of the accuracy and can calculate the indicator value in a shorter time as compared with the case where the original data is used.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic diagram illustrating a relationship between a data center, a vehicle, and an information processing terminal, which is an embodiment of an information processing apparatus;

FIG. 2 is a graph showing original data, wherein the upper graph shows the transition of the applied voltage of the drive motor, the middle graph shows the transition of the temperature of the drive motor, and the lower graph shows the transition of the atmospheric pressure;

FIG. 3 is a flowchart illustrating a flow of processing executed by the processing device of the data center;

FIG. 4 is a graph showing an example in which original data is clustered using two feature amounts;

FIG. 5 is a graph showing an example of the relative frequency distribution of the applied voltage of the drive motor in the original data; and

FIG. 6 is a graph illustrating an example of the relative frequency distribution of the temperature of the drive motor in the original data.

### DETAILED DESCRIPTION OF EMBODIMENTS

### Configuration of Information Processing System

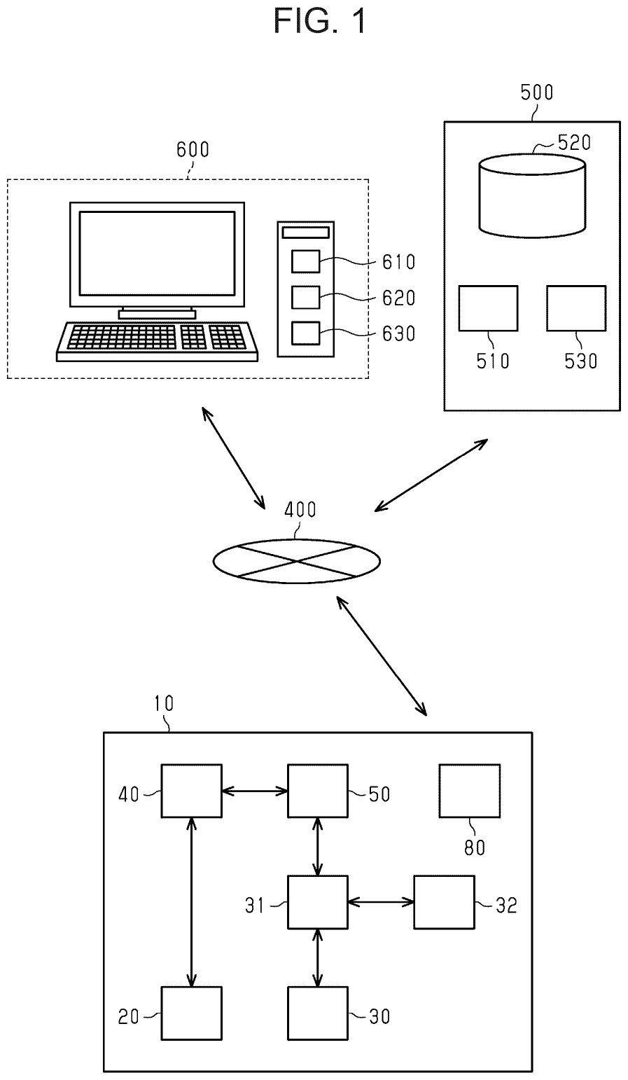

Hereinafter, a data center 500, which is an embodiment of an information processing apparatus, will be described with reference to FIG. 1 to FIG. 6. FIG. 1 shows a configuration of an information processing system including a data center 500. As shown in FIG. 1, the data center 500 communicates with the vehicle 10 via a communication network 400. The data center 500 also communicates with the information processing terminal 600 via the communication network 400. The data center 500 communicates with the plurality of vehicles 10 and the plurality of information processing terminals 600 via the communication network 400.

### Configuration of Data Center 500

As illustrated in FIG. 1, the data center 500 includes a processing device 510. The data center 500 includes a storage device 520 and a communication device 530. The processing device 510 includes a CPU that executes processing in accordance with a program, and a ROM in which the program is stored. The storage device 520 stores a large amount of data. The communication device 530 is implemented as hardware such as a network adapter, various communication software, or a combination thereof. The communication device 530 realizes wired or wireless communication via the communication network 400.

### Configuration of Vehicle 10

The data center 500 may be configured using a plurality of computers. For example, the data center 500 may be configured by a plurality of server apparatuses. Each of the plurality of vehicles 10 includes a communication device 80. The communication devices 80 are implemented as hardware such as a network adapter, various communication software, or a combination thereof. These communication devices 80 are configured to realize wired or wireless communication via the communication network 400.

Each vehicle 10 is equipped with an engine 20 and a drive motor 30. The vehicles 10 are hybrid electric vehicle. The vehicle 10 travels when the engine 20 and the drive motor 30 drive the drive wheels. The vehicle 10 includes an inverter 31 and a battery 32. The inverter 31 converts the DC voltage of the battery 32 into an AC voltage and outputs the AC voltage to the drive motor 30.

The vehicle 10 includes an engine control device 40 and a motor control device 50. The engine control device 40 controls the engine 20. The motor control device 50 controls the drive motor 30. For example, the motor control device 50 controls the voltage and frequency of an alternating current to be output to the drive motor 30 by controlling the inverter 31 with a rectangular wave.

The engine control device 40 and the motor control device 50 are equipped with various sensors that collect information on each part of the vehicle 10. In each vehicle 10, travel data is collected from the various sensors. The traveling data is transmitted from each vehicle 10 to the data center 500 by the communication device 80. For example, travel data including the travel distance, the position information, and the vehicle speed of each vehicle 10 is transmitted from each vehicle 10 to the data center 500. The travel data also includes various data indicating the state of the drive motor 30 acquired by the motor control device 50 of the vehicle 10. Identification information for identifying the respective vehicles 10 is also transmitted from the respective vehicles 10 to the data center 500 together with the traveling data.

The data center 500 stores the traveling data together with the received identification information in the storage device 520. In this way, traveling data of the plurality of vehicles 10 is accumulated in the storage device 520 of the data center 500.

### Configuration of Information Processing Terminal 600

The information processing terminal 600 includes a processing device 610, a storage device 620, and a communication device 630. The processing device 610 includes a CPU that executes processing in accordance with a program, and a ROM in which the program is stored. The storage device 620 stores data. The communication device 630 is implemented as hardware such as a network adapter, various communication software, or a combination thereof. The communication device 630 realizes wired or wireless communication via the communication network 400. The information processing terminal 600 is, for example, a personal computer.

### Analysis of Travel Data of Vehicle 10

The information processing terminal 600 is used to analyze travel data. When analyzing the traveling data, an instruction for executing the analysis is transmitted from the information processing terminal 600 to the data center 500. The processing device 510 of the data center 500 that has received the instruction performs analysis using a part of travel data among the enormous travel data stored in the storage device 520 of the data center 500. The travel data to be used is selected from the enormous amount of travel data stored in the storage device 520 in accordance with the purpose of analysis.

For example, the processing device 510 calculates a load applied to a specific component of the specific vehicle 10 based on travel data of the specific vehicle 10. The processing device 510 estimates the damage accumulated in the component based on the calculated load. For example, the processing device 510 calculates an index value indicating the magnitude of the damage accumulated in the drive motor 30 of the specific vehicle 10 based on the travel data of the specific vehicle 10. The processing device 510 of the data center 500 outputs the calculated result by transmitting the calculated result to the information processing terminal 600. The information processing terminal 600 that has received the result displays the received result.

In order to perform such an analysis, the processing device 510 analyzes a large amount of travel data collected over a long period of time. Since the processing device 510 needs to perform an enormous amount of computation, it takes a long time to analyze.

Therefore, it is conceivable to extract the extracted data that captures the features of the entire original data from a large amount of travel data that is the original data. If such extracted data can be extracted, the processing device 510 can perform analysis in a shorter time by using the extracted data. For example, in the case of estimating the damage of the drive motor 30 when traveling for 0.1 million hours, the processing device 510 estimates the damage using the extracted data for 20000 hours extracted from the original data for 0.1 million hours. Then, the processing device 510 multiplies the index value calculated from the extracted data for 20000 hours by 5 to calculate the index value of the damage of the drive motor 30 when the vehicle travels for 0.1 million hours.

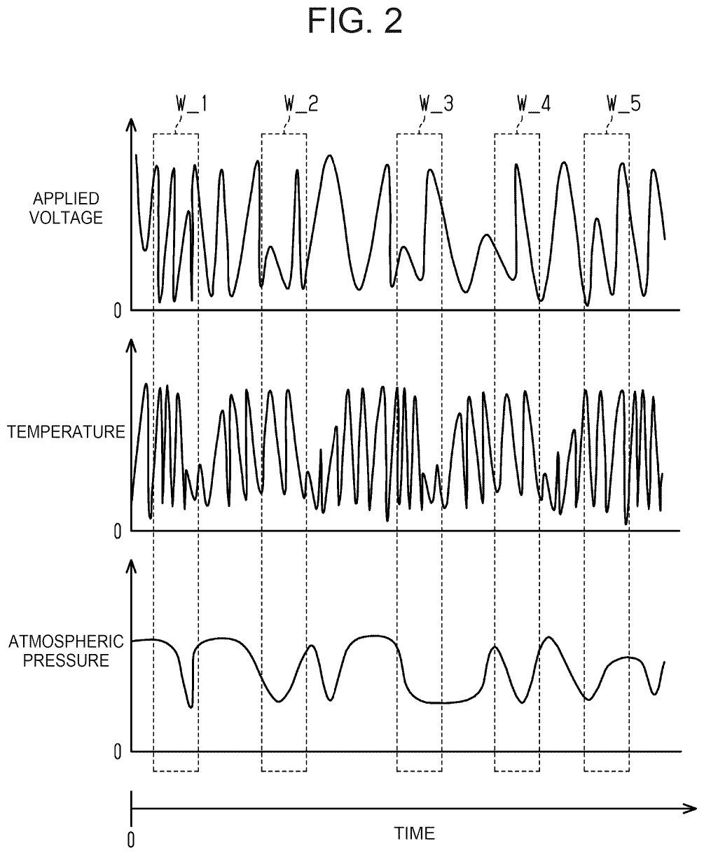

FIG. 2 illustrates an example of original data. The original data illustrated in FIG. 2 is a part of travel data for 0.1 million hours in one vehicle 10. The original data illustrated in FIG. 2 includes, as feature amounts, an applied voltage of the drive motor 30 to be subjected to calculation of an index value of damage, a temperature of the drive motor 30, and an atmospheric pressure in an installation environment of the drive motor 30.

The upper graph of FIG. 2 shows the transition of the applied voltage of the drive motor 30. The applied voltage is calculated by the motor control device 50. The applied voltage of the drive motor 30 can be calculated based on the state of the rectangular wave control of the inverter 31. For example, in the square-wave control, a pulsed switching signal for ON-OFF operating the switching elements of the inverter 31 is inputted from the motor control device 50 to the inverter 31. The voltage is estimated from the duty of ON. The applied voltage may be detected by a voltage sensor mounted on the vehicle 10.

The graph in the center of FIG. 2 shows the temperature transition of the drive motor 30. The temperature of the drive motor 30 can be detected by a temperature sensor mounted on the vehicle 10. The lower graph of FIG. 2 shows the transition of the atmospheric pressure. The atmospheric pressure in the installation environment of the drive motor 30 can be detected by an atmospheric pressure sensor mounted on the vehicle 10.

The applied voltage, the temperature, and the atmospheric pressure are correlated with the damage of the drive motor 30 of the vehicle 10. The processing device 510 of the data center 500 estimates the damage of the drive motor 30 from the travel data including the applied voltage, the temperature, and the atmospheric pressure as the feature amount.

The extracted data is created by clipping the data from the original data by a plurality of time windows. In FIG. 2, as an example of a plurality of time windows, five time windows of the first time window W_1, the second time window W_2, the third time window W_3, the fourth time window W_4, and the fifth time window W_5 are indicated by broken lines, respectively. The beginning and end of each time window are set such that the respective time windows do not overlap. In this example, the traveling data for 20000 hours is extracted as the extracted data. Therefore, the number of time windows and the beginning and end of each time window are set such that the length of the total period of all time windows is 20000 hours.

The data center 500 searches for the setting of the start time and the end time of each time window indicating the cut-out pattern for extracting the extracted data that captures the features of the entire original data. The data center 500 extracts the extracted data from the original data by using the cut-out pattern found by the search. The data center 500 performs analysis using the extracted data.

### Searching for Cut Patterns

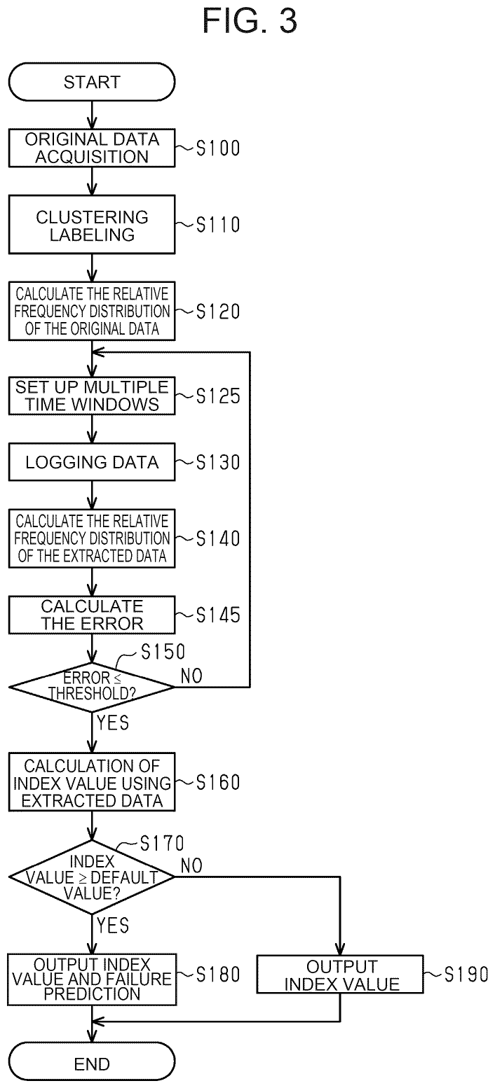

FIG. 3 is a flowchart illustrating a flow of a series of processes related to the extraction pattern search process. This series of processing is executed by the processing device 510 of the data center 500.

As illustrated in FIG. 3, the processing device 510 acquires the original-data in the processing of S100. The original data is a part of the travel data selected for the purpose of analysis from the enormous travel data stored in the storage device 520 of the data center 500. For example, the original data for calculating the index value indicating the magnitude of the damage accumulated in the drive motor 30 of one vehicle 10 is travel data over a predetermined period of the target vehicle 10 selected from the huge travel data of the plurality of vehicles 10. For example, in the case of estimating the damage of the drive motor 30 when traveling for 0.1 million hours, the original data is traveling data over a predetermined period of the target vehicle 10.

In the S110 process, the processing device 510 labels the original data by clustering. Specifically, the processing device 510 divides the original data at regular intervals. The length of the period for separating the original data is, for example, several minutes. Then, the processing device 510 executes clustering which is machine learning for classifying the data of each section into a predetermined number of clusters. For example, k-means method is used as the algorithm of clustering. k-means method is a clustering algorithm for classifying data into a predetermined number of clusters. The clustering algorithm is not limited to k-means method.

The original data includes travel data collected under different environments, such as travel data when traveling in an urban area, travel data when traveling in a suburban area, and travel data when traveling on an expressway. By performing clustering, the travel data included in the original data can be classified into clusters of travel data having similar characteristics. The number of clusters to be classified is arbitrarily set according to the contents of the analysis.

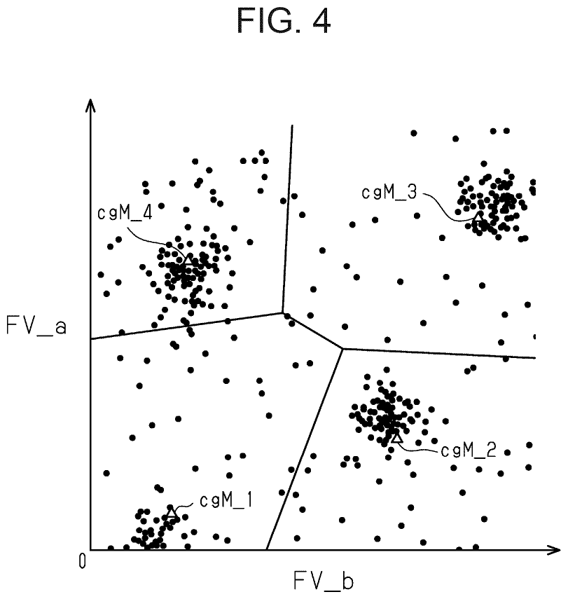

FIG. 4 is a graph illustrating an exemplary clustering of original data into four clusters by a k-means method using two feature amounts included in original data as explanatory variables. For example, the two feature values are the applied voltage and the temperature shown in FIG. 2. In FIG. 4, each piece of data in each section partitioned from the original data is indicated by a single point. When performing clustering, the processing device 510 uses a representative value of an explanatory variable in the data of each section. For example, the processing device 510 sets the average value of the feature amounts in the data of each section as a representative value. The processing device 510 may use, as the representative value, the moving average value of the feature amounts in a plurality of consecutive sections in time series.

In FIG. 4, these points are shown in a two-dimensional space with the first feature amount FV_a and the second feature amount FV_b as coordinate axes. FIG. 4 is an example in which original data is clustered in four clusters of the first cluster M_1, the second cluster M_2, the third cluster M_3, and the fourth cluster M_4. In FIG. 4, the boundaries of the four clusters are indicated by solid lines. In FIG. 4, the center of gravity of each cluster is indicated by an open triangle. The center of gravity cgM_1 is the center of gravity of the first cluster M_1. The center of gravity cgM_2 is the center of gravity of the second cluster M_2. The center of gravity cgM_3 is the center of gravity of the third cluster M_3. The center of gravity cgM_4 is the center of gravity of the fourth cluster M_4.

Although FIG. 4 shows two examples of explanatory variables, the number of explanatory variables is not limited to two. For example, as in the example illustrated in FIG. 2, when the original data includes three feature amounts of an applied voltage, a temperature, and an atmospheric pressure as feature amounts, the processing device 510 may perform clustering using these three feature amounts as explanatory variables. In this case, the processing device 510 clusters the original data in the three-dimensional coordinate space.

The processing device 510 assigns a label indicating the result of the clustering in this way to the original data. Specifically, each data indicated by a point in the coordinate space is given a label for identifying a cluster in which the data is classified. In this way, the processing device 510 creates the original data to which the label is attached.

Next, the processing device 510 calculates the relative-frequency distribution of the original-data in the processing of S120. As described above, the original data includes a plurality of feature amounts. The processing device 510 calculates a relative frequency distribution in the original data for each feature amount.

The frequency distribution classifies data into a plurality of classes, and represents a frequency distribution that is the number of data of each class. The relative frequency indicates how much the frequency of the class accounts for the sum of the total frequencies.

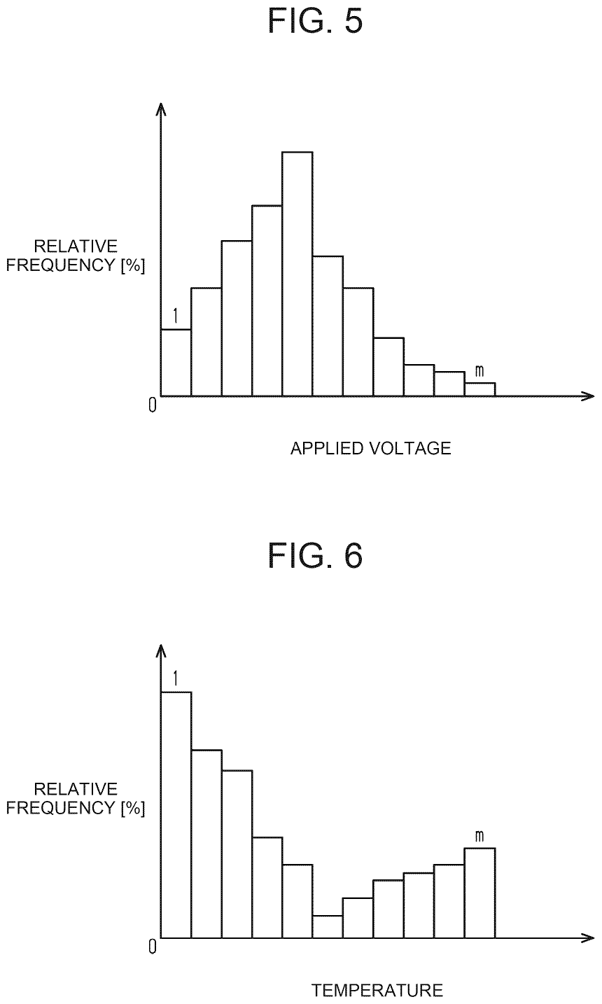

FIG. 5 shows the relative frequency distribution for the applied voltage in the original data shown in FIG. 2. In this relative frequency distribution, the class of the applied voltage in the original data is divided into m classes from 1 to m, and the relative frequency distribution is shown.

FIG. 6 shows the relative frequency distribution for temperature in the original data shown in FIG. 2. In this relative frequency distribution, the classes of temperature in the original data are divided into m classes from 1 to m to show the relative frequency distribution.

In S120 process, the processing device 510 calculates the relative-frequency-distribution for the respective feature values included in the original-data. The number of classes in the relative frequency distribution of each feature is the same.

For example, as in the example illustrated in FIG. 2, when the original data includes three feature amounts, i.e., the applied voltage, the temperature, and the atmospheric pressure, as the feature amounts, the processing device 510 calculates the relative frequency distribution of each of the three feature amounts.

Next, in the S125 process, the processing device 510 sets a plurality of time-windows in order to extract the extracted data from the original data. FIG. 2 shows five time windows W_1 to W_5 of the first time window W_1, the second time window W_2, the third time window W_3, the fourth time window W_4, and the fifth time window W_5 as an example of a part of the plurality of time windows. In the example shown in FIG. 2, the time periods of each time window are all equal. As illustrated in FIG. 2, the data cut out by each cut-out window is data of each feature amount in the same period.

In the S125 process, the processing device 510 randomly sets a plurality of time windows such that the total time period of all time windows is shorter than a predetermined time period, which is the total time period of the original data. As will be described later, the processing device 510 combines all the data cut out by the plurality of time windows set here to generate extracted data. The total time period of all the time windows is a value for determining the capacity of the extracted data. Therefore, a period in which all the time windows are summed is set in advance.

For example, the processing device 510 randomly sets the number of time windows, the start of each time window, and the end of each time window each time the S125 process is executed. At this time, the processing device 510 sets each time window so that each time window does not overlap. The processing device 510 thus randomly sets the plurality of time windows such that the total period of all time windows is a preset period. In the S125 process, the processing device 510 may set a plurality of time windows by fixing the time periods of the time windows to be constant, as illustrated in FIG. 2. In the S125 process, the processing device 510 may fix the plurality of time windows to a fixed number and set the plurality of time windows.

In addition to the above-described requirements, the processing device 510 sets a plurality of time windows when setting a plurality of time windows through S125 as follows. That is, the processing device 510 sets a plurality of time windows such that the difference between the ratio of each cluster in the extracted data and the ratio of each cluster in the entire original data is equal to or less than the threshold value.

In this way, by setting a plurality of time-windows through the S125 process, a cut-out pattern in which data is cut out from the original data is determined. When the processing device 510 determines the cut-out pattern in this way, the processing proceeds to S130.

In the S130 process, the processing device 510 cuts out data from the original data in the determined cutout pattern. That is, in the S130 process, the processing device 510 cuts out data from the original data by a plurality of set time-windows. Then, the processing device 510 combines all the data cut out by the plurality of time windows to create extracted data.

In the process of the following S140, the processing device 510 calculates the relative-frequency distribution of the extracted data. The processing device 510 calculates the relative frequency distribution of the extracted data in the same manner as the method of calculating the relative frequency distribution in S120. In other words, in the S140 process, the processing device 510 calculates the relative-frequency distribution of the extracted data for each feature value. At this time, the processing device 510 sets the number of grades in the relative frequency distribution of the respective feature amounts to be the same as the relative frequency distribution in S120.

For example, as shown in FIG. 2, when the original data includes three characteristic amounts of the applied voltage, the temperature, and the atmospheric pressure as the characteristic amounts, the processing device 510 calculates the relative frequency distributions of the three characteristic amounts in S140.

Next, in S145 process, the processing device 510 calculates an error between the relative frequency distribution in the original data and the relative frequency distribution in the extracted data. For example, the processing device 510 calculates a mean absolute error (MAE). The mean absolute error MAE is expressed by the following equation.

$$MAE = \frac{1}{n} \text{?} \vert \text{?} - \text{?} \vert$$

$$\text{?} \text{indicates text missing or illegible when filed}$$

In the above equation, “n” is the number of feature quantities. “m” is the number of series in the relative frequency distribution. “Y” is the frequency of the corresponding feature amount in the original data in the corresponding class. “y” is the frequency of the corresponding feature amount in the extracted data in the corresponding class.

As shown in the above equation, the processing device 510 calculates, as an error, the sum of the errors of the frequencies in the respective classes for each feature amount between the relative frequency distribution in the entire original data and the relative frequency distribution in the extracted data.

After calculating the error, the processing device 510 advances the processing to S150. In S150 process, the processing device 510 determines whether or not the calculated error is less than or equal to the thresholds. The threshold value is a value for determining whether or not the extracted data having the relative frequency distribution close to the relative frequency distribution in the original data is extracted by the set cutout pattern. The magnitude of the threshold is set in advance so that it can be determined that extracted data having a relative frequency distribution close to the relative frequency distribution in the original data is extracted based on the error being equal to or smaller than the threshold.

In S150 process, when it is determined that the error is equal to or smaller than the threshold (S150: YES), the processing device 510 advances the process to S160. In S160 process, the processing device 510 calculates the target index using the extracted data generated in the process of the latest S130. Here, an index value indicating the magnitude of the damage accumulated in the drive motor 30 is calculated. For example, the processing device 510 calculates the degree of damage as an index value indicating the magnitude of damage accumulated in the drive motor 30.

The degree of damage is an index value representing the rate of damage accumulated, assuming that the damage of the drive motor 30 gradually accumulates, assuming that the damage resulting in damage is “1”. Here, the damage applied to the drive motor 30 during a certain period of time is calculated from the applied voltage and the temperature. Then, the degree of damage that the drive motor 30 is damaged is set to “1”, and the calculated ratio of the damage is calculated as an index value. By repeating this process, the degree of damage, which is the ratio of accumulated damage to the calculated damage, is calculated. When the degree of damage becomes “1”, the damage is caused, and the calculated degree of damage is a value from “0” to “1”.

Here, since the damage degree is calculated using the extracted data which is a part of the original data, the processing device 510 converts the calculated damage degree into a size corresponding to the original data, and calculates the damage degree as the index value. For example, when the original data is traveling data for 0.1 million hours and the extracted data is traveling data for 20000 hours, the calculated degree of damage is multiplied by 5 to obtain the degree of damage as the index value.

On the other hand, in S150 process, when it is determined that the error is larger than the threshold (S150: NO), the processing device 510 returns the process to S125. Then, the processing device 510 re-executes the search processing from S125 to S145.

In this way, the processing device 510 repeatedly executes the search processing from S125 to S145 by changing the settings of the plurality of time-windows, and extracts extracted data in which the error becomes equal to or less than the threshold value from the original data. Then, the processing device 510 calculates an index value using the extracted data. After calculating the index, the processing device 510 advances the processing to S170.

In S170 process, the processing device 510 determines whether or not the index value is equal to or greater than a predetermined value. The default value is a value for predicting that damage is more likely to occur based on the fact that the index value is equal to or larger than the default value. For example, “0.9” can be set here, for example, as a default value in the degree of damage. In this case, it is possible to predict that the possibility of the damage is high based on the fact that the damage has reached 90% of the damage leading to the damage.

In S170 process, when it is determined that the index value is equal to or greater than the predetermined value (S170: YES), the processing device 510 advances the process to S180. In S180 process, the processing device 510 outputs an index and a failure estimate. Specifically, the processing device 510 transmits the index value and the failure prediction to the information processing terminal 600 that has transmitted the instruction for requesting the analysis.

The failure prediction is, for example, a message indicating that the occurrence of a failure has been predicted. In this way, when the calculated index value is equal to or greater than the predetermined value, the processing device 510 notifies that the occurrence of the failure has been predicted. The failure prediction may be information of a lifetime until a failure occurs. For example, when the degree of damage calculated by using the extracted data extracted from the original data for 0.1 million hours is the index value, the processing device 510 calculates the traveling time until the degree of damage reaches “1” and outputs the calculated traveling time as the information of the life. The information on the life may be converted into the traveling distance based on the traveling distance of 0.1 million hours and output.

In S170 process, when it is determined that the index value is less than the predetermined value (S170: NO), the processing device 510 advances the process to S190. In S190 process, the processing device 510 outputs an index. Specifically, the processing device 510 transmits the index value to the information processing terminal 600 that has transmitted the instruction for requesting the analysis.

### Operation of this Embodiment

When S180 or S190 process is executed, the processing device 510 terminates the series of processes. The data center 500, which is the information processing apparatus of the present embodiment, acquires original data collected and created over a predetermined period using a plurality of sensors mounted on the vehicle 10, and calculates an index value indicating the magnitude of damage accumulated in the drive motor 30.

The data center 500 includes a processing device 510 that executes processing. The original data includes data of an applied voltage of the drive motor 30, data of a temperature of the drive motor 30, and data of an atmospheric pressure of an installation environment of the drive motor 30 as feature amounts. In the data center 500, the search process executed by the processing device 510 includes a first step (S120) of calculating, for each feature quantity, a relative frequency distribution in the original data for a plurality of feature quantities included in the original data. The searching process includes a second step (S125) of setting a plurality of time windows for cutting out data of a part of the period of the original data such that the period of time of all the time windows is less than the predetermined period of time. The search process includes a third step (S130) of extracting data from the original data by a plurality of time-windows. The search process includes a fourth step (S140) of calculating, for each characteristic quantity, the relative frequency distribution in the extracted data obtained by combining all the data cut out by the plurality of temporal windows. The search process includes a fifth step (S145) of calculating an error between the relative frequency distribution in the original data and the relative frequency distribution in the extracted data. After executing the first step, the processing device 510 executes a search process in which the trials from the second step to the fifth step are repeatedly executed by changing the settings of a plurality of time windows. Then, the processing device 510 extracts the extracted data in which the error is equal to or less than the threshold (S150: YES). The processing device 510 calculates an index value using the extracted data in which the error becomes equal to or smaller than the threshold value (S160).

According to the data center 500, it is possible to obtain extracted data in which features of the entire original data including a plurality of feature amounts are captured. Therefore, the data center 500 can calculate the index value with the same accuracy as in the case of using the original data by using the extracted data having a smaller data amount than the original data.

### Effect of this Embodiment

(1) According to the data center 500 that is the information processing apparatus of the present embodiment, it is possible to achieve both reduction in the amount of data and calculation accuracy of the index value.

(2) According to the data center 500 which is the information processing apparatus of the present embodiment, it is possible to calculate the index value in a shorter time than in the case where the original data is used.

(3) The processing device 510 performs clustering, which is machine learning for classifying the data of the sections obtained by dividing the original data into a predetermined number of clusters at regular intervals (S110). Then, in the second step (S125) of the search process, the processing device 510 sets a plurality of time-windows such that the difference between the ratio of each cluster in the extracted data and the ratio of each cluster in the entire original data is equal to or less than the threshold.

A plurality of sections classified into the same cluster are sections having similar characteristics. In the above-described search process, the setting output from the processing device 510 is a setting in which the difference between the ratio of the entire original data and each cluster is equal to or less than the threshold value, and the extracted data having the relative frequency distribution of each feature amount close to each other can be extracted.

Therefore, according to the search process executed by the data center 500, it is possible to find a setting that can obtain extracted data closer to the characteristics of the entire original data.

(4) The processing device 510 terminates the search process when one piece of extracted data whose error becomes equal to or smaller than the threshold value can be extracted, and calculates an index value using the extracted data whose error becomes equal to or smaller than the threshold value. Therefore, the data center 500 can calculate an index value at a time point when one piece of extracted data whose error becomes equal to or smaller than the threshold value can be extracted, and output the result promptly.

(5) When the calculated index value is equal to or greater than the predetermined value (S170: YES), the processing device 510 notifies that a failure has been predicted. Therefore, the data center 500 can notify the user that the occurrence of the failure has been predicted before the failure occurs.

(6) The processing device 510 calculates a degree of damage as an index value. Therefore, the data center 500 can inform the user of how long the delay until the failure is reached.

### Example of Change

The present embodiment can be modified as follows. The present embodiment and the following modifications can be implemented in combination with each other within a technically consistent range.
Although the applied voltage of the target drive motor 30 for which the index value of damage is to be calculated and the temperature of the drive motor 30 are exemplified as the feature amount, the index value may be calculated by further including the oil temperature data in the feature amount. The characteristic quantity may include data of the driving state of the pump that supplies oil to the conductor portion of the drive motor 30. The data of the driving state of the pump may be data of an elapsed time from the driving or stopping of the pump. The feature amount may include data of the acceleration of the vehicle 10.
In the above embodiment, an example in which the information processing apparatus is embodied as the data center 500 has been described. An example in which the index value is calculated in the data center 500 has been described. On the other hand, the information processing apparatus described above may be embodied as the information processing terminal 600. In this case, the calculation of the index value is executed by the processing device 610 of the information processing terminal 600. The above-described information processing apparatus may be embodied as a control device of the vehicle 10. In this case, the calculation of the index value can also be performed by the control device of the vehicle 10. For example, the calculation of the index value can be executed by the motor control device 50 of the vehicle 10.
In the above-described embodiment, an example has been described in which one piece of extracted data is extracted and an index value is calculated. On the other hand, a final index value may be determined by extracting a plurality of pieces of extracted data and using a plurality of index values calculated using the respective pieces of extracted data. For example, the minimum value, the maximum value, the mode value, and the average value are set as final index values. Further, a plurality of index values may be output.
In the above-described embodiment, an example has been described in which, when the index value is equal to or larger than a predetermined value, it is notified that the occurrence of a failure has been predicted. This may be omitted. After the index value is calculated, only S190 process may be executed, and only the index value may be outputted.
Although the degree of damage is exemplified as an example of the index value to be calculated, the index value to be calculated is not limited to the degree of damage.
The index value of the damage of the plurality of drive motors 30 may be calculated. The respective relative frequency distributions may be calculated for the feature quantities of the respective drive motors 30, and the cut-out pattern may be searched so that the error of the relative frequency distributions for all the feature quantities becomes small.
The cut-out pattern may be searched for so that the relative frequency distribution becomes smaller with respect to the feature quantity for each drive motor 30. The index value may be calculated for each drive motor 30.

Vehicle 10 may be a battery electric vehicle that is not equipped with an engine. Only drive motor 30 is used as a power source.
The processing device 510 sets a plurality of time windows such that a difference between a ratio of each cluster in the original data and a ratio of each cluster in the extracted data is equal to or smaller than a threshold value. Without such a restriction, the processing device 510 may set a plurality of time windows. In such cases, the S110 process that performs clustering may be omitted.
The method of determining the setting of the time window in the cut-out pattern may not be random. The trial may be repeated by changing the setting of the time window in the clipping pattern according to a preset rule.
The error calculated in S145 process is not limited to the mean absolute error MAE. For example, the processing device 510 may calculate a mean square error as an error. The processing device 510 may calculate a root mean square error as an error.
An example using extracted data obtained by combining all extracted data is shown. On the other hand, some of the extracted data may be combined to create extracted data.

What is claimed is:

1. An information processing apparatus that acquires original data collected and created over a prescribed period of time using a plurality of sensors mounted in a vehicle and calculates an indicator value that indicates how large damage accumulated in a drive motor is, the information processing apparatus comprising a processing device configured to execute processing, wherein:
the original data includes, as feature amounts, data regarding a voltage applied to the drive motor; and
the processing device executes
search processing that includes a first step of calculating, for each of the feature amounts, a relative frequency distribution in the original data in regard to the feature amounts included in the original data, a second step of setting a plurality of time windows for cutting data corresponding to partial periods of the original data such that a period obtained by adding up periods of all the time windows is shorter than the prescribed period, a third step of cutting data from the original data using the plurality of time windows, a fourth step of calculating, for each of the feature amounts, the relative frequency distribution in extracted data obtained by connecting the data cut using the plurality of time windows, and a fifth step of calculating an error between the relative frequency distribution in the original data and the relative frequency distribution in the extracted data, a trial from the second step to the fifth step being repeated with a setting of the plurality of time windows changed after execution of the first step to extract the extracted data with which the error is equal to or less than a threshold value in the search processing, and
calculating the indicator value using the extracted data with which the error is equal to or less than the threshold value.

2. The information processing apparatus according to claim 1, wherein:
the processing device executes clustering which is machine learning of categorizing data of each section obtained by sectioning the original data for each specific period into a prescribed number of clusters; and
the processing device sets the plurality of time windows such that a difference between a ratio of each cluster in the extracted data and a ratio of each cluster in entire original data is equal to or less than a threshold value in the second step.

3. The information processing apparatus according to claim 1, wherein the original data includes, as the feature amounts, data regarding a temperature of the drive motor and data regarding an atmospheric pressure.

4. The information processing apparatus according to claim 1, wherein the processing device calculates a degree of breakage indicating a proportion of accumulated damage with respect to damage that leads to breakage as the indicator value.
